(19) United States
(12) Patent Application Publication
(10) Pub. No.: US 2012/0026977 A1
(43) Pub. Date: Feb. 2, 2012

(54) METHOD AND APPARATUS FOR HANDOVER IN A MULTI-CARRIER SYSTEM

(76) Inventors: So Yeon Kim, Anyang-si (KR); Jae Hoon Chung, Anyang-si (KR); Yeong Hyeon Kwon, Anyang-si (KR)

(21) Appl. No.: 13/255,832

(22) PCT Filed: Mar. 11, 2010
(86) PCT No.: PCT/KR10/01514

§ 371 Date: Sep. 9, 2011

Related U.S. Application Data
(60) Provisional application No. 61/159,430, filed on Mar. 11, 2009.
(60) Provisional application No. 61/224,059, filed on Jul. 9, 2009.

(30) Foreign Application Priority Data
Mar. 11, 2010 (KR) 10-2010-0021570

(51) Int. Cl. H04W 36/00

(52) U.S. Cl. 370/331

(57) ABSTRACT

A method and an apparatus for handover in a multi-carrier system are provided. A user equipment receives multi-carrier measurement information from a base station, and measures carriers based on the multi-carrier measurement information. The user equipment performs a handover with a target base station through an access reference carrier which is one of a plurality of component carriers of which the measurement result is reported. The present invention minimizes a delay caused by the handover, and reduces battery consumption of the user equipment.

### TECHNICAL FIELD

The present invention relates to wireless communication and, more particularly, to a method and apparatus for performing handover in a wireless communication system supporting a multi-carrier

### BACKGROUND ART

In a conventional wireless communication system, although an uplink bandwidth and a downlink bandwidth are differently set, only one carrier is chiefly taken into consideration. The carrier is defined by the center frequency and the bandwidth. A multi-carrier system uses a plurality of carriers having a bandwidth smaller than the entire bandwidth.

LTE (long term evolution) based on 3GPP (3rd Generation Partnership Project) TS (Technical Specification) Release 8 is the leading next-generation mobile communication standard.

A 3GPP LTE system supports only one (i.e., one carrier) of {1.4, 3, 5, 10, 15, and 20} MHz bandwidths. A multi-carrier system may use two carriers, each having a 20 MHz bandwidth, or three carriers having a 20 MHz bandwidth, a 15 MHz bandwidth, and a 5 MHz bandwidth, respectively, in order to support the entire 40 MHz bandwidth.

A multi-carrier system has advantages in that it can support backward compatibility with the existing system and also increase the data rate through multiple carriers.

Meanwhile, a wireless communication system divides the service area into a number of cells and provides communication service in order to overcome the limitation of a service area and the limitation of a user accommodation capacity. This is called a multi-cell environment. A cell is an area where a base station provides communication service. A base station can provide service to at least one cell. An user equipment belongs to one cell, and the cell to which the user equipment belongs is called a serving cell. A cell adjacent to the serving cell is called a neighbor cell.

A wireless communication system differs from a wired communication system in that it has to provide seamless service to user equipments having mobility. That is, if an user equipment moves from a serving cell to a neighbor cell, seamless service can be provided to the user equipment only if the neighbor cell is changed into the serving cell. A procedure of changing the serving cell of the user equipment owing to the movement of the user equipment as described above is called handover. Here, a cell to which the user equipment originally belongs is called a source cell, and a new cell to which the user equipment has moved is called a target cell. A base station providing the source cell with communication service is called a source base station, and a base station providing the target cell with communication service is called a target base station.

If handover is delayed, user equipment cannot perform reliable communication and the quality of service (QoS) is adversely affected.

There is a need for a scheme capable of performing handover in a multi-carrier system.

### DISCLOSURE

### Technical Problem

The present invention provides a method and apparatus for performing handover in a multi-carrier system

The present invention also provides a method and apparatus for performing cell search in a multi-carrier system.

### Technical Solution

In an aspect, there is provided a handover method in a multi-carrier system. The method includes receiving multi-carrier measurement information from a base station, performing measurement based on the multi-carrier measurement information, reporting a measurement result to the base station, and performing handover with a target base station through an access reference carrier of component carriers for which the measurement result has been reported, wherein the multi-carrier measurement information indicates at least one component carrier within each neighbor cell, and the measurement result indicates a measurement result for the at least one component carrier within each neighbor cell.

The multi-carrier measurement information may be information about a center frequency for the at least one component carrier within each neighbor cell.

The step of performing handover may include receiving a handover command from the base station, performing synchronization with the target base station, transmitting a random access preamble to the target base station, and receiving a random access response in response to the random access preamble from the target base station.

The synchronization with the target base station may be performed through the access reference carrier.

In another aspect, a user equipment supporting multiple carriers includes a radio frequency unit configured to transmit and receive a radio signal, and a processor connected to the RF unit and configured to receive multi-carrier measurement information from a base station, perform measurement based on the multi-carrier measurement information, report a measurement result to the base station, and perform handover with a target base station through an access reference carrier of component carriers for which the measurement result has been reported, wherein the multi-carrier measurement information indicates at least one component carrier within each neighbor cell, and the measurement result indicates a measurement result for the at least one component carrier within each neighbor cell.

### Advantageous Effects

Communication quality can be improved by minimizing delay dring handover. Furthermore, battery consumption of an user equipment used in signal measurement for multiple carriers can be reduced.

### DESCRIPTION OF DRAWINGS

FIG. 1 shows a wireless communication system.

FIG. 2 shows the structure of a radio frame in 3GPP LTE.

FIG. 3 is a flowchart illustrating an example of a successful handover process.

FIG. 4 shows an example in which multiple carriers are operated.

FIG. 5 shows an example in which multiple carriers are operated.

FIG. 6 is a flowchart illustrating a handover process according to an embodiment of the present invention.

FIG. 7 shows another example of the handover process.

FIG. 8 is a block diagram showing a wireless communication system in which an embodiment of the present invention is implemented.

### MODE FOR INVENTION

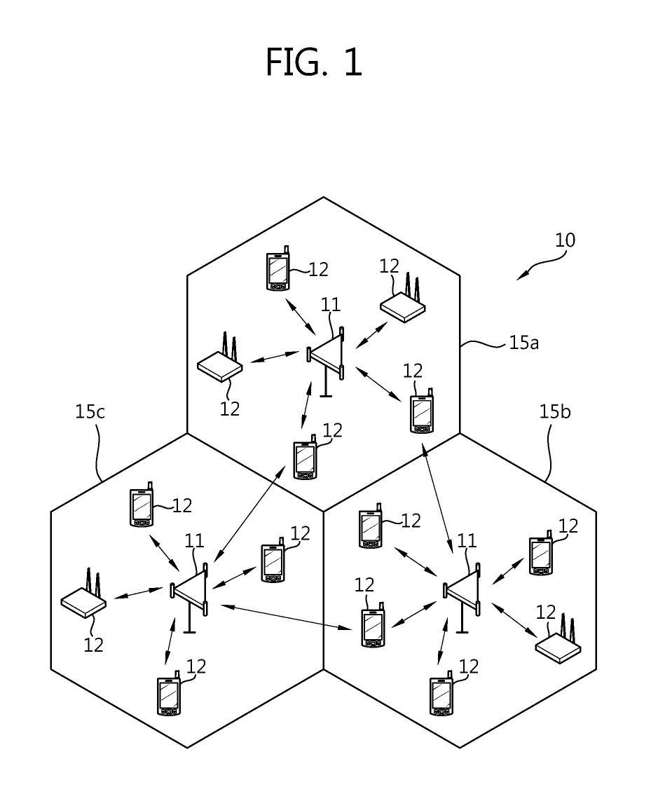

FIG. 1 shows a wireless communication system. A wireless communication system 10 includes one or more base stations (BSs) 11. The BSs 11 provide communication services to respective geographical regions (commonly called cells) 15a, 15b, and 15c. The cell may be divided into a number of regions (called sectors).

An user equipment (UE) 12 may be fixed or mobile. The UE may be called another terminology, such as an MS (mobile station), an MT (mobile terminal), a UT (user terminal), an SS (subscriber station), a wireless device, a PDA (personal digital assistant), a wireless modem, or a handheld device.

The BS 11 commonly refers to a fixed station which communicates with the UEs 12. The BS may also be called another terminology, such as an eNB (evolved-NodeB), a BTS (Base Transceiver System), or an access point.

Hereinafter, downlink (DL) refers to communication from a BS to UE, and uplink (UL) refers to communication from UE to a BS. In downlink, a transmitter may be part of a BS, and a receiver may be part of UE. In uplink, a transmitter may be part of UE, and a receiver may be part of a BS.

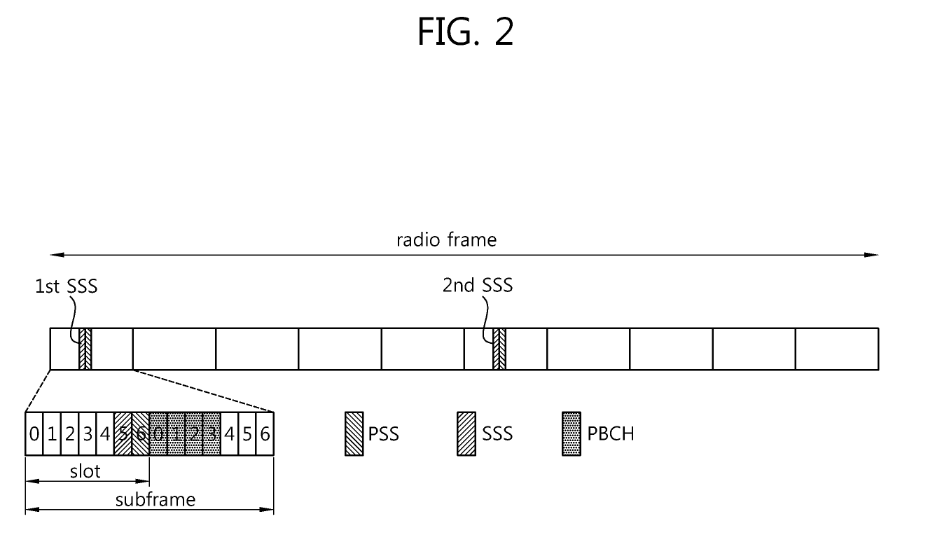

FIG. 2 shows the structure of a radio frame in 3GPP LTE. For the structure of the radio frame, reference can be made to Section 6 of 3GPP TS 36.211 V8.5.0 (2008-12) “Evolved Universal Terrestrial Radio Access (E-UTRA); Physical Channels and Modulation (Release 8)”. The radio frame consists of 10 subframes assigned respective indices 0 to 9. One subframe consists of 2 slots. The time taken to transmit one subframe is called a TTI (transmission time interval). For example, the length of one subframe may be 1 ms, and the length of one slot may be 0.5 ms.

One slot may include a plurality of OFDM (orthogonal frequency division multiplexing) symbols in the time domain. The OFDM symbol is used to represent one symbol period in the time domain because 3GPP LTE adopts OFDMA (orthogonal frequency division multiplexing) symbols in downlink, but not limited to a multi-access scheme or a name. For example, the OFDM symbol may be called another terminology, such as an SC-FDMA (single carrier frequency division multiple access) symbol or a symbol period.

One slot is illustrated to include 7 OFDM symbols, but the number of OFDM symbols included in one slot may be changed according to the length of a CP (Cyclic Prefix). In accordance with 3GPP TS 36.211 V8.5.0 (2008-12), one subframe includes 7 OFDM symbols in a normal CP and includes 6 OFDM symbols in an extended CP.

A resource block (RB) is a unit of resource allocation, and it includes a plurality of subcarriers in one slot. For example, assuming that one slot includes 7 OFDM symbols in the time domain and the resource block includes 12 subcarriers in the frequency domain, one resource block may include 7×12 resource elements (REs).

A PSS (Primary Synchronization Signal) is transmitted through the last OFDM symbols of a first slot (i.e., the first slot of a first subframe (a subframe having an index 0)) and an eleventh slot (i.e., the first slot of a sixth subframe (a subframe having an index 5)). The PSS is used to obtain OFDM symbol synchronization or slot synchronization and is associated with a physical cell ID (identity). A PSC (Primary Synchronization Code) is a sequence used for the PSS. Three PSCs are included in 3GPP LTE. One of the three PSCs is transmitted as the PSS according to a cell ID. The same PSC is used in the last OFDM symbols of the first slot and the eleventh slot.

An SSS (Secondary Synchronization Signal) includes a first SSS and a second SSS. The first SSS and the second SSS are transmitted through an OFDM symbol contiguous to an OFDM symbol through which the PSS is transmitted. The SSS is used to obtain frame synchronization. The SSS, together with the PSS, is used to obtain a cell ID. The first SSS and the second SSS use different SSCs (Secondary Synchronization Codes). Assuming that each of the first SSS and the second SSS includes 31 subcarriers, two SSC sequences each having a length of 31 are used in the first SSS and the second SSS, respectively.

A PBCH (Physical Broadcast Channel) is transmitted over the former four OFDM symbols of the second slot of a first subframe. The PBCH carries pieces of essential system information necessary for UE to communicate with a BS. System information transmitted through the PBCH is called an MIB (master information block). On the other hand, system information transmitted through a PDCCH (Physical Downlink Control Channel) is called an SIB (system information block).

As disclosed in 3GPP TS 36.211 V8.5.0 (2008-12) of LTE, physical channels are divided into a PDSCH (Physical Downlink Shared Channel) and a PUSCH (Physical Uplink Shared Channel) which are data channels and a PDCCH (Physical Downlink Control Channel) and a PUCCH (Physical Uplink Control Channel) which are control channels. Furthermore, downlink control channels include a PCFICH (Physical Control Format Indicator Channel) and a PHICH (Physical Hybrid-ARQ Indicator Channel).

Control information transmitted through a PDCCH is called downlink control information (DCI). The DCI may include the resource allocation of a PDSCH (also called a downlink grant), the resource allocation of a PUSCH (also called an uplink grant), a set of transmit power control command for individual UEs within a certain UE group, and/or the activation of the VoIP (Voice over Internet Protocol).

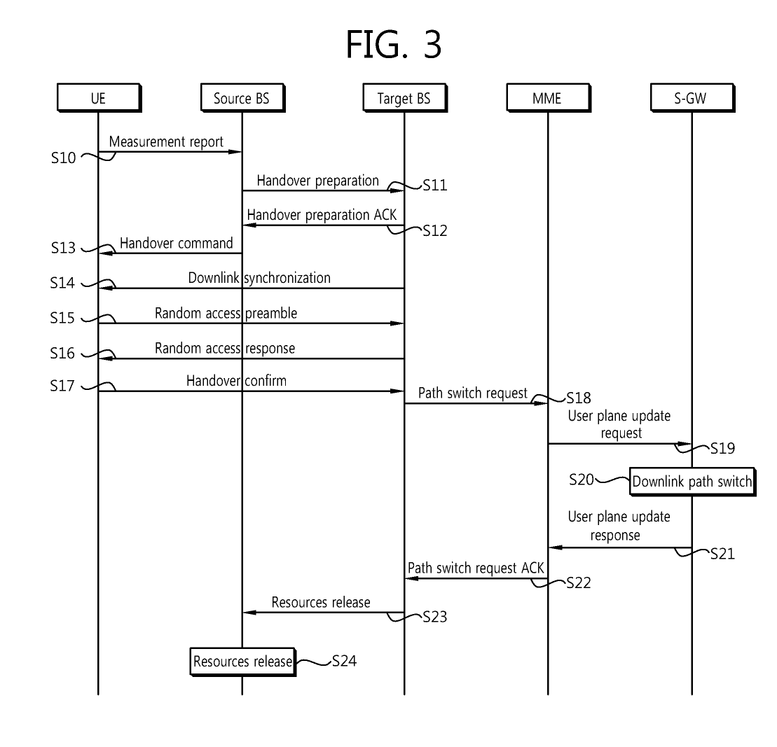

FIG. 3 is a flowchart illustrating an example of a successful handover process.

A UE transmits a measurement report to a source BS (S10). The source BS determines whether to perform handover based on the received measurement report. If the source BS determines to perform handover to a neighbor cell, the neighbor cell becomes a target cell and a BS belonging to the target cell becomes a target BS.

The source BS transmits a handover preparation message to a target BS (S11). The target BS performs admission control in order to increase a possibility a successful handover.

The target BS transmits a handover preparation ACK (Acknowledgement) message to the source BS (S12). The handover preparation ACK message may include a C-RNTI (Cell-Radio Network Temporary Identifier) and/or a dedicated random access preamble. The C-RNTI is an identifier for distinguishing UEs from one another within a cell. The dedicated random access preamble is a preamble that may be exclusively used by UE for a certain period of time and is used when a non-contention-based random access process is performed. A random access process may be divided into a contention-based random access process in which UE uses a specific random access preamble and a non-contention-based random access process in which UE uses the dedicated random access preamble. The non-contention-based random access process can prevent delay of handover due to contention with other UEs as compared with the contention-based random access process.

The source BS transmits a handover command message to the UE (S13). The handover command message may be transmitted in the form of an RRC (Radio Resource Control) connection reconfiguration message. The handover command message may include the C-RNTI and the dedicated random access preamble received from the target BS.

After receiving the handover command message from the source BS, the UE is synchronized with the target BS (S14). The UE performs synchronization by receiving the PSS and the SSS of the target BS and obtains system information by receiving a PBCH.

The UE starts a random access process by transmitting a random access preamble to the target BS (S15). The UE may use the dedicated random access preamble included in the handover command message. Alternatively, if the dedicated random access preamble is allocated, the UE may use a random access preamble randomly selected from a set of random access preambles.

The target BS transmits a random access response message to the UE (S16). The random access response message may include uplink resource allocation and/or timing advance.

The UE which has received the random access response message controls uplink synchronization based on the timing advance and transmits a handover confirm message to the target BS using the uplink resource allocation (S17). The handover confirm message indicates that the handover process has been completed, and it may be transmitted along with an uplink buffer status report.

The target BS informs an MME (Mobility Management Entity) that the cell of the UE has been switched by transmitting a path switch request message to the MME (S18).

The MME transmits a user plane update request message to an S-GW (Serving-Gateway) (S19).

The S-GW switches a downlink data path to the target BS (S20).

The S-GW transmits a user plane update response message to the MME (S21).

The MME transmits a path switch request ACK message to the target BS (S22).

The target BS informs the source BS of a success of the handover by transmitting a resource release message to the source BS (S23).

The source BS releases resources related to the UE (S24).

A multi-carrier system is described below.

A 3GPP LTE system supports a case where a downlink bandwidth and an uplink bandwidth are differently set. Here, one component carrier (CC) is a precondition for the case. This means that, in the state in which one CC is defined for each of downlink and uplink, 3GPP LTE supports a case where the downlink bandwidth is identical with or different from the uplink bandwidth. For example, the 3GPP LTE system may support a maximum of 20 MHz and have different uplink bandwidth and downlink bandwidth, but supports only one CC in uplink and downlink.

A spectrum aggregation (also called a bandwidth aggregation or a carrier aggregation) supports a plurality of CCs. The spectrum aggregation has been introduced in order to support an increased throughput, prevent an increase of costs due to the introduction of a wideband RF (radio frequency), and guarantee compatibility with the existing system. For example, if 5 CCs are allocated as the granularity of a carrier unit having a 20 MHz bandwidth, a maximum bandwidth of 100 MHz can be supported.

The spectrum aggregation may be divided into a contiguous spectrum aggregation in which an aggregation is performed between consecutive carriers and a non-contiguous spectrum aggregation in which an aggregation is performed between inconsecutive carriers, in the frequency domain. The number of carriers aggregated between downlink and uplink may be differently set. A case where the number of downlink carriers is identical with the number of uplink carriers is called a symmetric aggregation, and a case where the number of downlink carriers is different from the number of uplink carriers is called an asymmetric aggregation.

CCs may have different sizes (i.e., bandwidths). For example, assuming that 5 CCs are used to configure a 70 MHz bandwidth, it may be configured using a 5 MHz carrier (carrier #0)+a 20 MHz carrier (carrier #1)+a 20 MHz carrier (carrier #2)+a 20 MHz carrier (carrier #3)+a 5 MHz carrier (carrier #4).

The term ‘multi-carrier system’ hereinafter refers to a system supporting multiple carriers based on the spectrum aggregation. In the multi-carrier system, a contiguous spectrum aggregation or a non-contiguous spectrum aggregation or both may be used, and any one of a symmetric aggregation and an asymmetric aggregation may be used.

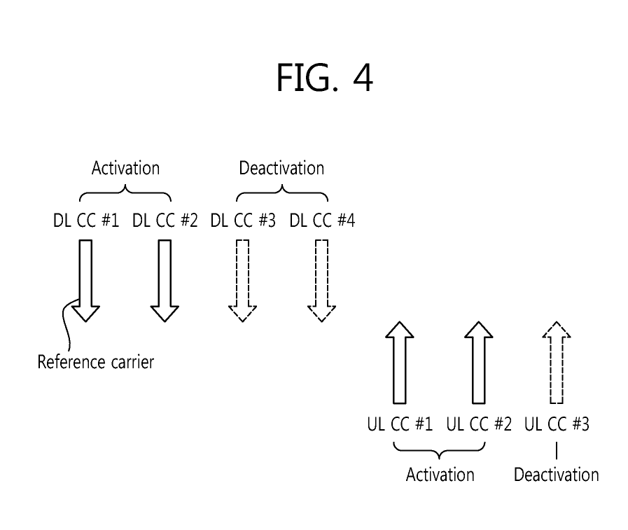

FIG. 4 shows an example in which multiple carriers are operated. Four DL CCs (i.e., a DL CC #1, a DL CC #2, a DL CC #3, and a DL CC #4) and three UL CCs (i.e., an UL CC #1, an UL CC #2, and an UL CC #3) are illustrated, but the number of CCs is not limited.

The DL CC #1 and the DL CC #2 of the four DL CCs are activated, which are called activated carriers. The DL CC #3 and the DL CC #4 are deactivated, which are called deactivated carriers. Furthermore, the UL CC #1 and the UL CC #2 of the three UL CCs are activated carriers, and the UL CC #3 thereof is an activated carrier.

The activated carrier is a carrier enabling the transmission or reception of control information or a data packet. The activated carrier does not enable the transmission or reception of a data packet, but enables a minimum operation, such as signal measurement.

The activated carrier and the activated carrier are not fixed, and each CC may be deactivated or activated through negotiations between a BS and UE. The deactivated carrier is also called a candidate carrier in that the deactivated carrier can be activated.

At least one of the activated carriers may be set as a reference carrier. The reference carrier is also called an anchor carrier or a primary carrier. A carrier not the reference carrier is called a secondary carrier. The reference carrier is a carrier in which control information is transmitted on a downlink control channel (e.g., a PDCCH) or in which common control information for multiple carriers is transmitted.

A mobility management message or a carrier activation/deactivation message may be transmitted through the reference carrier.

The reference carrier may be defined not only for downlink, but also for uplink. The uplink reference carrier may be used to send at least one of uplink control information (UCI), an HARQ ACK/NACK signal, an aperiodic CQI, and a periodic CQI. Furthermore, the uplink reference carrier may be used to perform handover and perform initial access, such as the transmission of a random access preamble.

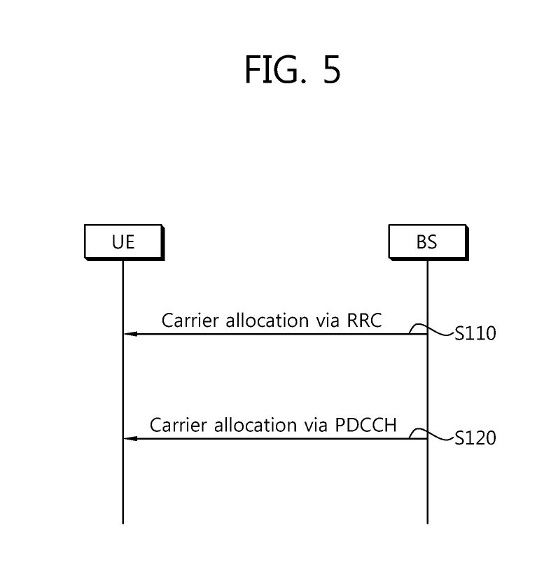

FIG. 5 shows an example in which multiple carriers are operated.

A BS first informs UE of higher carrier allocation information through a higher layer message, such as an RRC (S110). The higher carrier allocation information is information about activated downlink/uplink carriers that may be used between the UE and the BS. Furthermore, the higher carrier allocation information includes information about the configuration of a reference carrier.

The BS informs the UE of lower carrier allocation information through dynamic signaling, such as a PDCCH (S120). The lower carrier allocation information may indicate used carriers, from among activated carriers received through higher lower carrier allocation information. Alternatively, the lower carrier allocation information may override higher carrier allocation information.

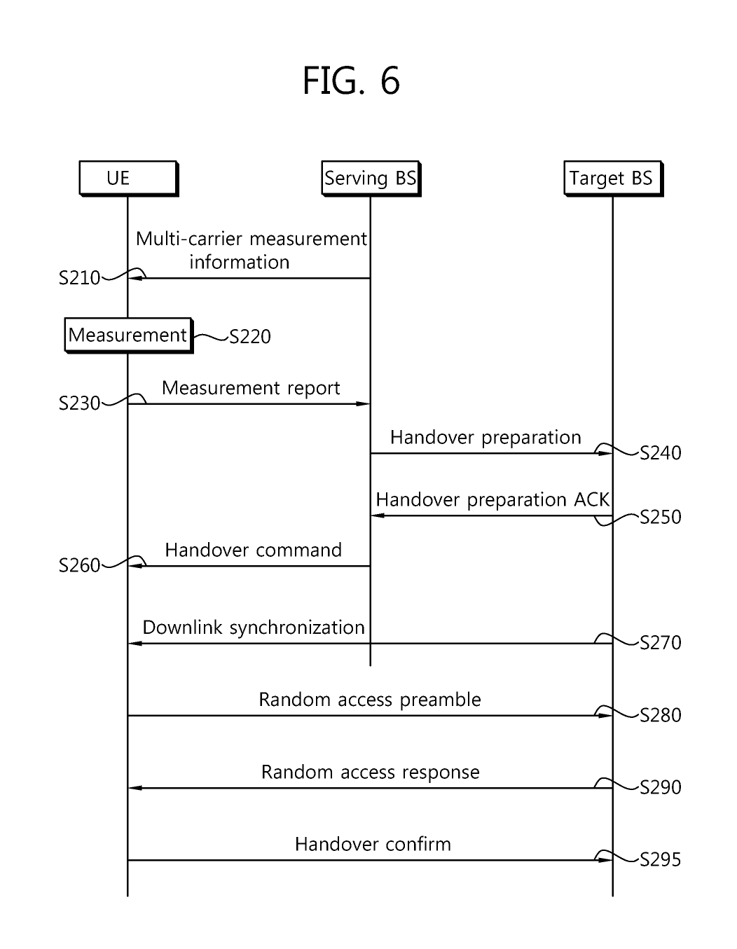

FIG. 6 is a flowchart illustrating a handover process according to an embodiment of the present invention.

A source BS transmits multi-carrier measurement information to UE (S210). The UE performs measurement based on the multi-carrier measurement information (S220).

The multi-carrier measurement information includes information about a CC on which the measurement has been performed, from among the CCs of a neighbor cell. The multi-carrier measurement information indicates information about at least one measured CC, from among a plurality of CCs used (or activated) within each cell.

For example, assuming that there are C1 and C2 in the neighbor cell, an example of multi-carrier measurement information may be represented as follows.

TABLE 1

| | |
|---|---|
| C1 = {cf1, cf2} | C2 = {cf1} |

Each of cf1 and cf2 indicates the center frequency of a measured CC. C1 measures two CCs, and C2 measures one CC, but the number of CCs measured is not limited.

When a neighbor cell is measured, if a measurement report for all measured CCs is made after all CCs or all activated CCs are measured, overhead may occur because the size of a message used in the measurement report is increased. Accordingly, only some CCs are limitedly measured based on multi-carrier measurement information in order to reduce a burden due to measurement and a measurement report. Accordingly, battery consumption of UE used for measurement can be reduced, and signaling overhead can be reduced.

At least one of measured CCs may be used as an access reference carrier for handover to be described later.

If a plurality of CCs within a cell is the subject of measurement, the order of priority may be assigned to each of the plurality of CCs. A CC having a high order of priority is first measured. If the intensity of a signal of the CC is lower than a reference value, a CC having a lower order of priority is measured.

The UE transmits a measurement report to the source BS (S230). The measurement report may be transmitted through an uplink CC linked to a downlink CC through multi-carrier measurement information is transmitted, or the measurement report may be transmitted through an uplink reference carrier.

The source BS determines whether to perform handover based on the received measurement report and transmits a handover preparation message to a target BS (S240).

The target BS transmits a handover preparation ACK message to the source BS (S250). The handover preparation ACK message may include a C-RNTI (Cell-Radio Network Temporary Identifier) and/or a dedicated random access preamble.

The source BS transmits a handover command message to the UE (S260). The handover command message may include the C-RNTI and the dedicated random access preamble received from the target BS. The handover command message may be transmitted through a downlink reference carrier.

In the cell measurement or cell research step, the UE has already performed measurement for limited CCs. Accordingly, additional information about multiple carriers is not required in the handover command message. Accordingly, compatibility with the existing single carrier can be maintained.

Alternatively, the handover command message may include information about the configuration of multiple carriers by a target BS. Multi-carrier configuration information may indicate information about the multi-carrier capability and/or access uplink/downlink reference carrier of the target BS.

The access reference carrier refers to a carrier that is initially used in order for UE to access a target BS, and one or more CCs may be used as the access reference carrier.

After receiving the handover command message from the source BS, the UE is synchronized with the target BS (S270). The UE performs synchronization by receiving the PSS and the SSS of the target BS and obtains system information by receiving an MIB or an SIB or both. A downlink CC used for synchronization may be a downlink CC used for cell measurement. This is called an access downlink reference carrier. Since a downlink CC used for cell measurement is used for synchronization, additional information is not required and the delay of synchronization can be prevented.

The UE starts a random access process by transmitting a random access preamble to the target BS (S280). The UE may use the dedicated random access preamble used in the handover command message. The random access preamble may be transmitted through an access uplink reference carrier, and information about the access uplink reference carrier may be obtained through the handover command message.

The target BS transmits a random access response message to the UE (S290). The random access response message may be transmitted through an access downlink reference carrier.

The UE transmits a handover confirm message to the target BS in order to indicate the completion of the handover process (S295).

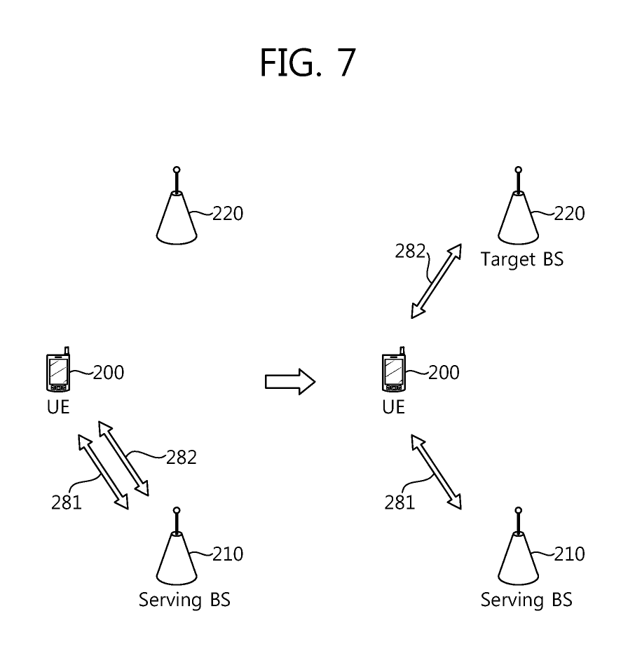

FIG. 7 shows another example of the handover process. A figure on the left side indicates ex-handover, and a figure on the right side indicates in-handover.

It is assumed that UE 200 has a multi-carrier capability of using two CCs. Prior to the start of handover, the UE 200 communicates with a serving BS 210 through a first CC 281 and a second CC 282.

When the handover is started in response to the handover command of the serving BS 210, the UE 200 continues to communicate with the serving BS 210 through the first CC 281, but perform the handover with the target BS 220 through the second CC 282.

If the handover with the target BS 220 is successfully finished, the UE may release the connection with the serving BS 210 through the first CC. In order to release connection with the remaining CCs, the target BS 220 may inform the serving BS 210 of release information to release the connection. The received serving BS 210 may inform the UE of the release based on the release information.

If connection for all activated CC allocated in the existing serving BS 210 is released, the UE may obtain new carrier allocation from a new serving BS 220.

Meanwhile, a BS does not always allocate CCs corresponding to the capability of UE. Alternatively, CCs have been allocated to UE, but some of the CCs may not used. For example, assuming that UE has three multi-carrier capabilities, but only two of carriers have been allocated to the UE, handover may be performed through the remaining one carrier.

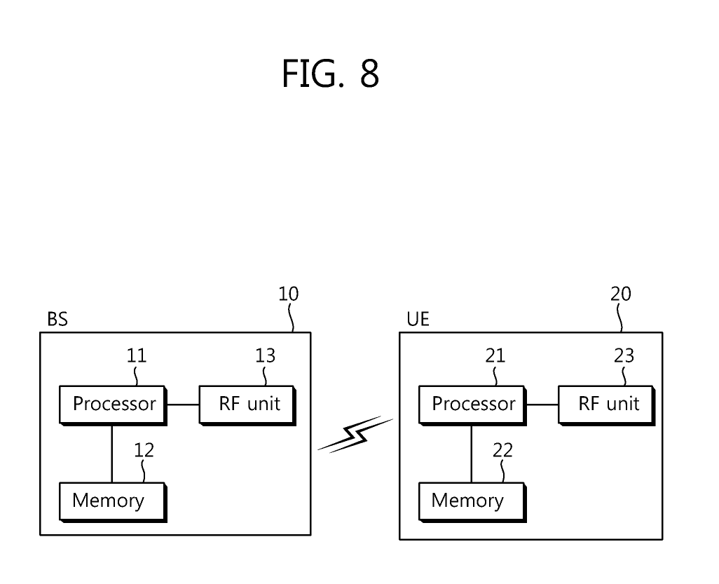

FIG. 8 is a block diagram showing a wireless communication system in which an embodiment of the present invention is implemented.

A BS 10 includes a processor 11, memory 12, and an RF unit (radio frequency) unit 13.

The processor 11 implements the proposed functions, processed, and/or methods. The operation of the BS 10 may be implemented by the processor 11. The processor 11 supports operations for multiple carriers and performs handover.

The memory 12 is connected to the processor 11 and configured to store protocols or parameters for multi-carrier operations. The RF unit 13 is connected to the processor 11 and configured to send and/or receive a radio signal.

A UE 20 includes a processor 21, memory 22, and an RF unit 23.

The processor 21 implements the proposed functions, processed, and/or methods. The operation of the UE 20 may be implemented by the processor 21. The processor 21 supports operations for multiple carriers and performs handover.

The memory 22 is connected to the processor 21 and configured to store protocols or parameters for multi-carrier operations. The RF unit 23 is connected to the processor 21 and configured to send and/or receive a radio signal.

The processors 11, 21 may include Application-Specific Integrated Circuits (ASICs), other chipsets, logic circuits, and/or data processors. The memories 12, 22 may include Read-Only Memory (ROM), Random Access Memory (RAM), flash memory, memory cards, storage media and/or other storage devices. The RF units 13, 23 may include a baseband circuit for processing a radio signal. When the embodiment is implemented in software, the above scheme may be implemented using a module (process or function) which performs the above function. The module may be stored in the memories 12, 22 and executed by the processors 11, 21. The memories 12, 22 may be placed inside or outside the processors 11, 21 and connected to the processors 11, 21 using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

The above-described embodiments include various aspects of examples. Although all possible combinations for describing the various aspects may not be described, those skilled in the art may appreciate that other combinations are possible. Accordingly, the present invention should be construed to include all other replacements, modifications, and changes which fall within the scope of the claims.

1-12. (canceled)

13. A method of performing a handover from a source base station to a target base station in a wireless communication system, comprising:
receiving, by a mobile station, from the source base station, a handover command to initiate a handover from the source base station to the target base station through a primary carrier of the source base station, the handover command including information indicating an access primary carrier of the target base station; and
performing, by the mobile station, a network entry procedure with the target base station through the access primary carrier of the target base station.

14. The method of claim 13, further comprising:
receiving, by the mobile station, from the source base station, a multi-carrier configuration including information on at least one neighbor base station and at least one carrier of each neighbor base station; and
performing, by the mobile station, measurements for at least one carrier of the at least one neighbor base station to determine the target base station.

15. The method of claim 14, wherein the step of performing the network entry procedure includes:
transmitting, by the mobile station, a preamble to the target base station; and
receiving, by the mobile station, a response for the preamble from the target base station through the access primary carrier.

16. The method of claim 15, further comprising:
wherein the handover command further includes information indicating the preamble which is dedicated for the handover.

17. The method of claim 13, further comprising:
stopping, by the mobile station, to communicating with the source base station after completing the handover.

18. A mobile station of performing a handover from a source base station to a target base station in a wireless communication system, comprising:
a radio frequency unit configured to transmit and receive radio signals; and
a processor operatively coupled with the radio frequency unit and configured for:
receiving, from the source base station, a handover command to initiate a handover from the source base station to the target base station through a primary carrier of the source base station, the handover command including information indicating an access primary carrier of the target base station; and
performing a network entry procedure with the target base station through the access primary carrier of the target base station.

19. The mobile station of claim 18, wherein the processor is configured for:
receiving, from the source base station, a multi-carrier configuration including information on at least one neighbor base station and at least one carrier of each neighbor base station; and
performing measurements for at least one carrier of the at least one neighbor base station to determine the target base station.

20. The mobile station of claim 19, wherein the processor is configured for performing the network entry procedure by:
transmitting a preamble to the target base station; and
receiving a response for the preamble from the target base station through the access primary carrier.

21. The mobile station of claim 20, wherein the handover command further includes information indicating the preamble which is dedicated for the handover.
